(19) United States
(12) Patent Application Publication
(10) Pub. No.: US 2011/0272204 A1
(43) Pub. Date: Nov. 10, 2011

(54) Hydraulic Power-Assisted Steering and Method for Determining Steering Wheel Torque

(76) Inventors: Joachim Nell, Berlin (DE); Ronald Bayer, Muhlheim/Main (DE); Steffen Linkenbach, Eschborn (DE); Jürgen Böhm, Obermeisen (DE); Oliver Hoffman, Frankfurt/M (DE); Andreas Schirling, Pfungstadt (DE); Norman Muth, Frankenberg (DE)

(21) Appl. No.: 11/631,999

(22) PCT Filed: Jul. 8, 2005
(86) PCT No.: PCT/EP05/53279

§ 371 Date: Jul. 17, 2008

(30) Foreign Application Priority Data
Jul. 9, 2004 (DE) 10 2004 033 686.5

(51) Int. Cl. B62D 6/10

(52) U.S. Cl. 180/441

(57) ABSTRACT

In a hydraulic power steering system with a steering gear and a hydraulic actuator for supporting a steering wheel actuation by the driver of a vehicle including a device for actively applying an additional steering torque, is disclosed. The device for actively applying an additional steering torque includes at least one additional torque actuator and a detector for detecting the steering torque, and the detector detects a hydraulic pressure.

### BACKGROUND OF THE INVENTION

The present invention relates to a hydraulic power steering system with a steering gear and a hydraulic actuator for supporting a steering wheel actuation by the driver of a vehicle, in particular a motor vehicle, with means associated therewith for actively applying an additional steering torque.

The invention also relates to a method, the purpose of which is to determine a steering torque for a hydraulic power steering system with a steering gear and a hydraulic actuator for supporting a steering wheel actuation by the driver of a vehicle, in particular a motor vehicle, with means associated therewith for actively applying an additional steering torque.

Up-to-date motor vehicles, in particular passenger vehicles, are generally equipped with hydraulic or electrohydraulic power steering systems, hereinbelow referred to as ‘hydraulic power steering systems’. The power assistance is configured such that actuators, e.g. hydraulic cylinders, are arranged in the medium range of the steering mechanism. A force generated by the actuators is used to support the actuation of the steering mechanism as a reaction to the rotation of the steering wheel (torque support). The torque being applied for steering the vehicle is thus reduced, and the driver is relieved during the steering maneuver.

It is known in the art to design the torque assistance or steering boosting speed-responsively. At low vehicle speeds being typical of pulling in or out of a parking space, a very easy-running steering system with a high degree of torque support is preferred, while heavier steering with a low degree of torque support is desirable at high driving speeds.

An object of the invention is to reduce the technical effort and structure in a hydraulic power steering system with a variable torque support, and to thereby reduce the producing costs.

### SUMMARY OF THE INVENTION

The term ‘steering wheel’ herein implies all feasible actuating devices for steering a vehicle such as a steering wheel, control stick, or ‘joystick’.

It is essential for the invention that the means for actively applying an additional steering torque comprise at least one additional torque actuator and a means detecting the steering torque, the said detecting means being a pressure detecting means for hydraulic pressure.

According to the invention, the pressure detecting means is arranged in a hydraulic conduit between a hydraulic pressure increasing unit (pump) and a steering valve.

According to the invention, the pressure detecting means is used to assess or determine a hydraulic pressure in a respectively active working chamber of a hydraulic actuator, in order to support a steering wheel actuation by the driver.

It is arranged for according to the invention that the additional torque actuator is designed as a unit, being arranged as a module at a steering wheel shaft that interconnects the steering wheel and the steering gear.

The invention discloses that the additional torque actuator includes an electric motor that is coupled to the steering column.

The invention discloses that the means for the active application of an additional steering torque includes an electric motor, a redundant electronic controlling and regulating unit (ECU), and a redundant steering wheel torque sensor.

The invention discloses that the means for the active application of an additional steering torque includes a gear cooperating with the additional torque actuator.

According to the invention, the gear is a belt drive, a helical worm gear, or a spur gear, preferably a belt drive.

The invention discloses that an electronic controlling and regulating unit (ECU) actuates the additional torque actuator to produce an additional steering wheel torque adapted to the current vehicle speed.

The invention discloses that the electronic controlling and regulating unit (ECU) actuates the additional torque actuator to produce an additional steering wheel torque that is adapted to the vehicle's course and the shape of the road.

To this end, favorably, there is provision of a nominal track detecting means for determining a nominal track or a nominal track angle from a detected or estimated shape of the road, an actual track detecting means for determining an actual track and an actual track angle from a detected or estimated vehicle course, a comparison means for comparing the nominal track and the nominal track angle with the actual track and the actual track angle, and a zero-point displacement means in order to displace the zero point of the characteristic curve for supporting the steering handle according to the comparison.

According to the invention, an electronic controlling and regulating unit (ECU) actuates the additional torque actuator to produce an additional steering wheel torque adapted to the current vehicle dynamics, in particular the current transverse acceleration.

According to the invention, the additional torque actuator is an electromechanical, electromagnetic, or hydraulic actuator.

The object of the invention is also achieved by a method, which is provided to determine a steering torque for a hydraulic power steering system, including a steering gear and a hydraulic actuator for supporting a steering wheel actuation by the driver of a vehicle, in particular a motor vehicle, associated with which is a means for the active application of an additional steering torque. The method is characterized in that hydraulic pressure is detected and the steering torque is assessed or determined according to the detected hydraulic pressure.

In the above method, preferably, a hydraulic pressure is detected in a hydraulic conduit between a hydraulic pressure increase unit (pump) and a steering valve.

It is arranged for according to the method of the invention that hydraulic pressure is detected, which corresponds to a hydraulic pressure in a respectively active working chamber of a hydraulic actuator to support a steering wheel actuation by the driver.

### BRIEF DESCRIPTION OF THE DRAWINGS

The invention will be explained exemplarily in more detail in the following description making reference to the accompanying drawings (FIG. 1 to FIG. 4).

FIG. 1 is a schematic view of an embodiment of the power steering system of the invention with an electromechanical actuator.

FIG. 2 is a schematic view of an embodiment of the power steering system of the invention with a hydraulic actuator.

FIG. 3 illustrates an embodiment of the power steering system of the invention with a magnetic additional torque actuator.

FIG. 4 depicts a characteristic curve of a power steering system.

### DETAILED DESCRIPTION OF THE DRAWINGS

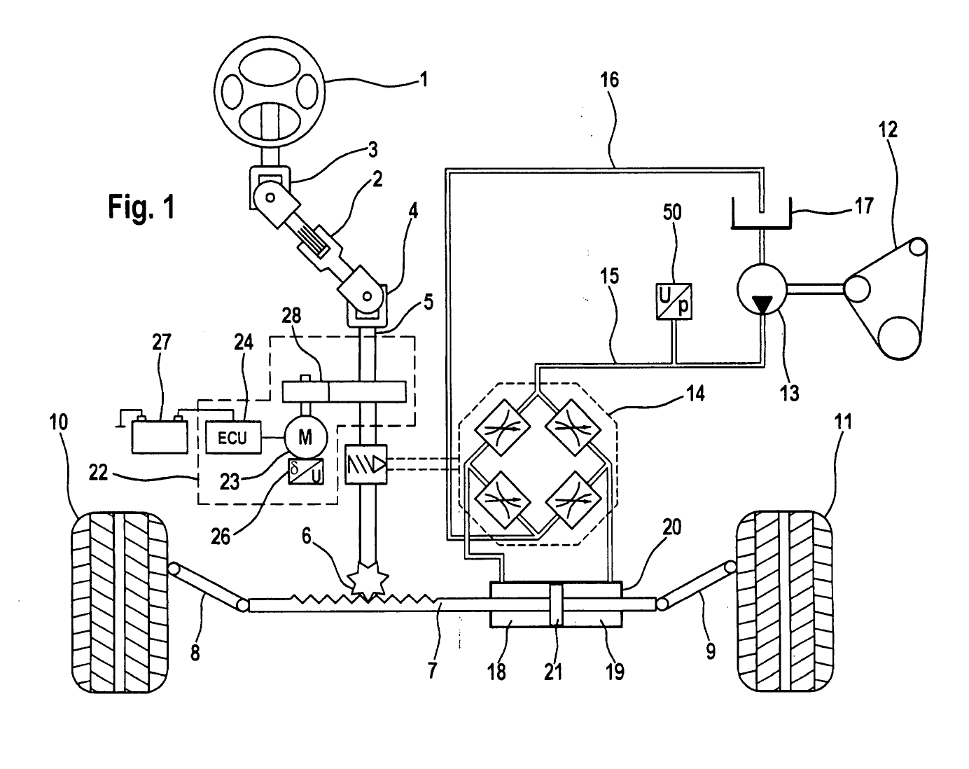

The steering system illustrated in FIG. 1 comprises a steering wheel 1, and a steering column 2 with two universal joints 3, 4 connected to the steering wheel 1. Steering column 2 is connected to or part of a steering wheel shaft 5 that actuates the steering tie rods 8, 9 secured laterally to a steering rack 7 by way of a steering gear 6, a steering rod 7, herein configured as steering rack, thereby causing tilting of the wheels 10, 11. In the rack-and-pinion steering shown herein, hydraulic boosting is realized by means of a hydraulic pump 13 driven by the driving engine of the vehicle, e.g. by means of a belt drive 12, said pump 13 conveying pressurized fluid to a steering valve 14 through a conduit 15. The pressure fluid can flow back into a supply tank 17 through a return conduit 16.

In the straight-ahead position of the steering wheel, a constant oil flow propagates through the steering valve being in its neutral position (open center) and back through the return conduit 16. The pressure in two chambers 18, 19 of a working cylinder 20 arranged on the steering rack 7 has an equal amount then. There is no power steering.

The steering rack 7 and, thus, piston 21 as well is displaced when the steering wheel 1 is turned. The pressure of the pressure fluid supports the movement of the piston 21. As this occurs, valve 14 additionally causes pressure fluid to flow from one chamber into the other chamber so that the whole steering actuation is hydraulically boosted.

The conventional hydraulic power steering system described above comprises a unit for producing an additional torque 22, including an additional torque actuator 23, herein an electric motor 23, a redundant control unit ECU 24 for actuating the motor 23 and evaluating signals of a means for detecting the steering torque (steering torque sensor 50), and a sensor for the engine position 26.

The driver steering torque measured by means of the detecting means 50 is required herein as an input quantity for controlling the booster characteristic curve of the additional torque actuator 23.

Favorably, pressure sensor 50 is less complicated under technical aspects than an electronic torque sensor in the steering wheel shaft 5. In addition, the hydraulic sensor 50 lends itself to integration into an existing system in a more favorable and simpler manner. The reason is that an arrangement of an electronic torque sensor in the steering wheel shaft frequently entails great effort and structure due to space conditions and the manifold different types of construction. In addition, an electronic torque sensor generally is a complicated and, thus, correspondingly expensive component. Therefore, the costs for the system of the invention are comparatively low as a whole.

The pressure detecting means 50 is favorably arranged in the hydraulic area between hydraulic pump 13 and steering valve 14. It is favorable for certain applications that the pressure detecting means 50 has a redundant design.

As the hydraulic pressure in the mentioned area corresponds to the pressure in the respectively active working chamber 18/19 of the working cylinder 20 with sufficient accuracy and the hydraulic boosting power can, thus, be determined with sufficient accuracy, the driver steering torque that acts on the steering wheel shaft 5 can be calculated with sufficient accuracy due to the known, non-variable geometric data of the overall steering system.

Thus, the quantity calculated from the hydraulic pressure will replace the driver steering torque measured by means of an electronic torque sensor in the steering wheel shaft 5.

The electronic components are connected to an electric energy source 27. The control unit ECU 24. Unit 22 also comprises the control unit ECU 24 herein. However, the control unit ECU 24 can also be arranged separately according to the invention. Preferably, unit 22 at least comprises an additional torque actuator 23, a steering torque sensor 25 and, as the case may be, a sensor for the engine position 26.

The unit for producing an additional torque 22 can influence actively the steering wheel torque or steering torque, which is defined by the steering system characteristics and the acting forces. As this occurs, the electric motor 23 generates an additional torque (additional steering torque) and applies it to the steering rod. There is the possibility of adding the torque to the steering wheel torque predefined by construction, or to deduct it therefrom. The engine torque can be transmitted with or without speed increasing ratio directly or, as illustrated herein, by way of a gear 28. The gear used herein can be a belt drive, a helical worm gear, or a spur gear.

When the unit for producing an additional torque fails, the servo-assisted steering characteristics known to the driver is preserved. Unit 22 is fail-silent to this end. This means it is deactivated in a case of malfunction.

Favorably, a conventional power steering system without modifications to the characteristics can be used by means of the unit of the invention producing an additional torque 22. Said unit is added as a module directly to a conventional hydraulic power steering system in order to gain in functions.

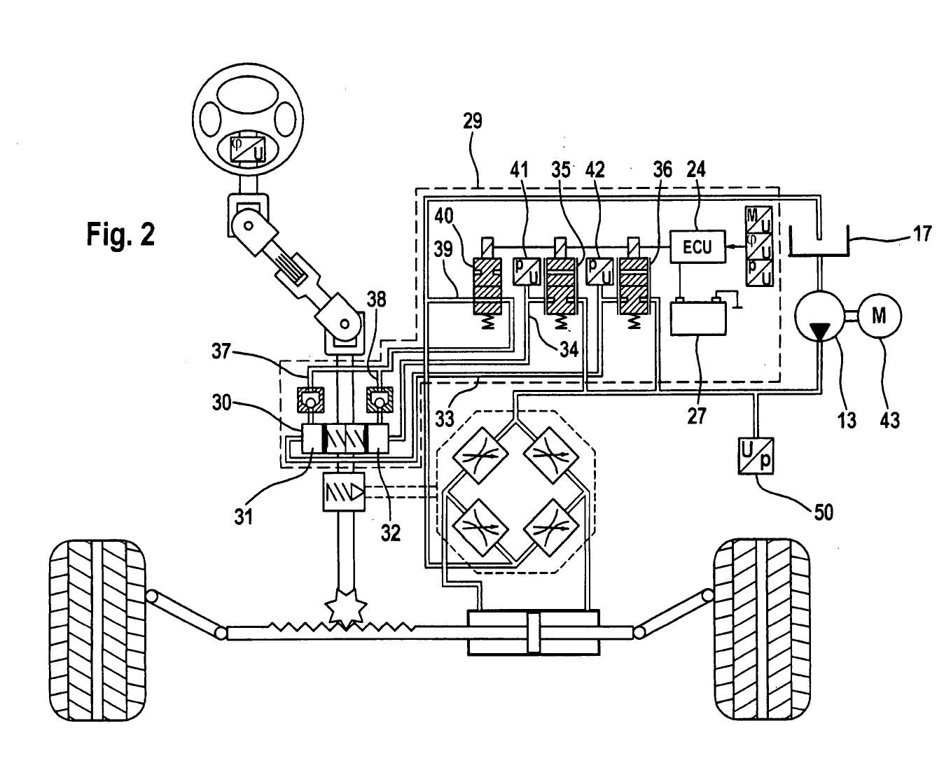

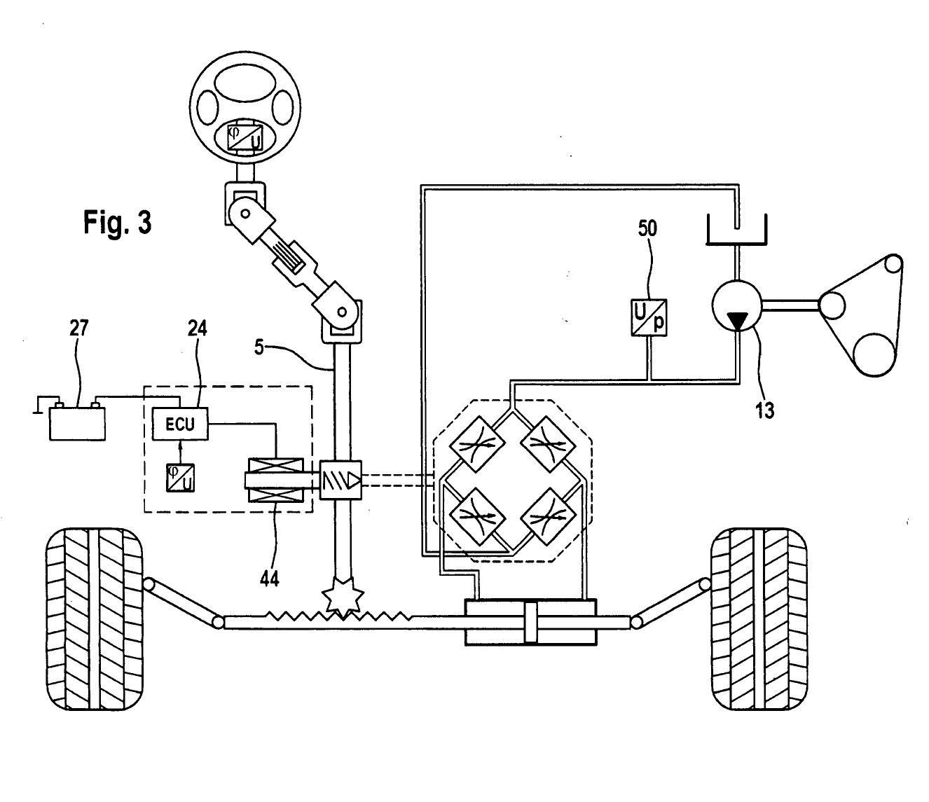

It is also possible to produce an additional torque by means of a hydraulic additional torque actuator (see FIG. 2) or by a magnetic additional torque actuator (see FIG. 3).

The basic steering system with hydraulic assistance is identical to the system shown in FIG. 1 and, therefore, will not be explained in detail.

A unit 29 with a hydraulic additional torque actuator 30 produces the additional torque in the system illustrated in FIG. 2. According to the invention, a pressure detecting means (pressure sensor 50) for a hydraulic pressure is employed as a detecting means for the steering torque.

The hydraulic additional torque actuator 30 includes two hydraulic chambers 31, 32 to which a pressurized fluid can be applied by way of hydraulic conduits 33, 34 in which one hydraulic, electromagnetically operable valve 35, 36 is respectively incorporated. From the hydraulic chambers 31, 32, the pressure fluid can be returned into the supply tank 17 by way of conduits 37, 38 into which respectively one non-return valve is inserted, and through a subsequent common conduit 39 into which a hydraulic, electromagnetically operable valve 40 is inserted.

For the purpose of pressure control in chambers 31, 32 and, thus, for additional torque control, valves 35, 36, 40 are actuated by a preferably redundant control unit ECU 24 on command of the signals of the detecting means for the steering torque (pressure sensor 50) and of two pressure sensors 41, 42.

Preferably, an electric motor 43 of its own, rather than (compulsorily) the driving engine of the vehicle (cf. FIG. 1), drives the pump in this arrangement. A corresponding actuation of the motor 43 allows the pump 13 to produce the hydraulic pressure in conformity to requirements, whereby energy can be economized.

An electromagnetic additional torque actuator 44 actuated by the control unit ECU 24 produces an additional torque in the embodiment illustrated in FIG. 3. According to the invention, a pressure detecting means (pressure sensor 50) for a hydraulic pressure is employed as a detecting means for the steering torque.

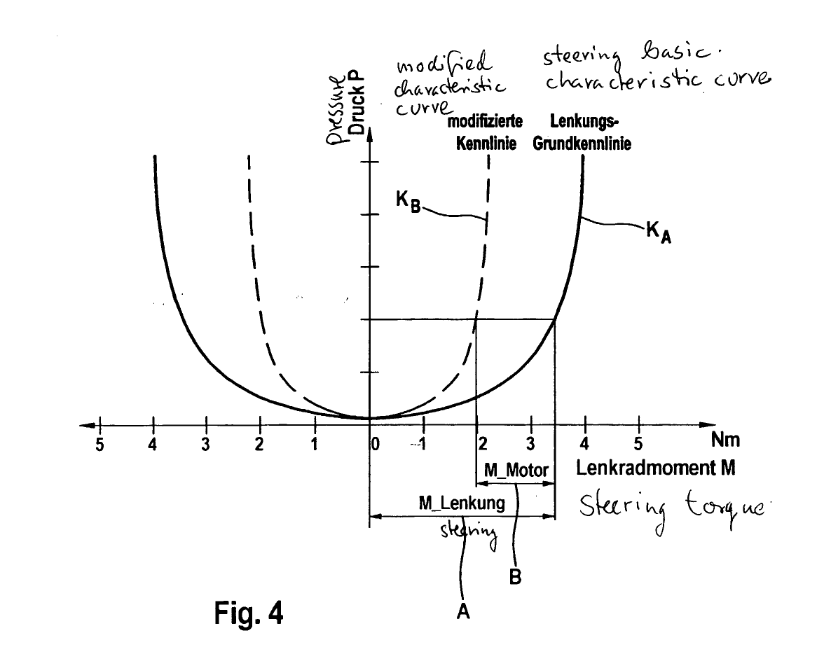

The invention renders it possible to vary the boosting characteristic curve by producing an additional torque (see FIG. 4). The boosting characteristic curve herein means the dependency of the steering wheel torque or the actuating torque M on the prevailing system pressure P of the hydraulic boosting. The torque A (M_steering) is reduced by active application of an additional torque B (M_Motor) in the example shown. This implies that the steering activity of the driver is supported to a greater extent. The result is a modified characteristic curve (dotted curve K_{B}) with a lower actuating force compared to the original characteristic curve (solid curve K_{A}). An active assistance can be imparted to the driver in addition. A steering recommendation is then given by way of a torque adaptation or variation, or excessive torque will render steering more difficult for the driver in order to warn him/her about hazards.

1-10. (canceled)

11. A hydraulic power steering system comprising:
a steering gear and a hydraulic actuator for supporting a steering wheel actuation by a driver of a vehicle, such as a motor vehicle, with having associated therewith a device for actively applying an additional steering torque, wherein the device for actively applying an additional steering torque includes at least one additional torque actuator and a detector for detecting steering torque, wherein the detector (50) detects a hydraulic pressure.

12. A system according to claim 11, wherein the pressure detector (50) is arranged in a hydraulic conduit between a hydraulic pressure increasing unit (pump 13) and a steering valve (14).

13. A system according to claim 11, the pressure detector (50) is used to assess or determine a hydraulic pressure in a respective active working chamber (18, 19) of a hydraulic actuator (20) to support a steering wheel actuation by the driver.

14. A system according to claim 11, wherein the additional torque actuator is designed as a unit, being arranged as a module at a steering wheel shaft that interconnects the steering wheel and the steering gear.

15. A system according to claim 11, wherein the additional torque actuator includes an electric motor that is coupled to a steering column.

16. A system according to claim 11, wherein the device for the active application of an additional steering torque includes an electric motor, a redundant electronic controlling and regulating unit (ECU), and in that a redundant steering wheel torque sensor (50) is provided.

17. A system according to claim 11, wherein the device for the active application of an additional steering torque includes a gear, in particular a belt drive, preferably a helical worm gear, or a spur gear, which cooperates with the additional torque actuator.

18. A method for determining a steering torque for a hydraulic power steering system with a steering gear and a hydraulic actuator for supporting a steering wheel actuation by the driver of a vehicle, such as a motor vehicle, with means associated therewith for actively applying an additional steering torque, the method comprising:
detecting a hydraulic pressure; and
determining a steering torque according to the detected hydraulic pressure.

19. A method according to claim 18, wherein a hydraulic pressure is detected in a hydraulic conduit between a hydraulic pressure increasing unit (pump 13) and a steering valve (14).

20. A method according to claim 18, wherein a hydraulic pressure is detected, which corresponds to a hydraulic pressure in a respectively active working chamber (18, 19) of a hydraulic actuator (20) for supporting a steering wheel actuation by the driver.
